(19) United States
(12) Patent Application Publication
(10) Pub. No.: US 2024/0169268 A1
(43) Pub. Date: May 23, 2024

(54) METHOD FOR FAIRNESS-AWARE DATA VALUATION PROCESSING FOR SUPERVISED LEARNING

(71) Applicant: FEEDZAI - CONSULTADORIA E INOVAÇÃO TECNOLÓGICA, S.A., Coimbra (PT)

(72) Inventors: JOSÉ MARIA PEREIRA ROSA CORREIA POMBAL, Coimbra (PT); PEDRO DOS SANTOS SALEIRO, Coimbra (PT); PEDRO GUSTAVO SANTOS RODRIGUES BIZARRO, Coimbra (PT)

(21) Appl. No.: 18/507,568

(22) Filed: Nov. 13, 2023

(30) Foreign Application Priority Data
Nov. 11, 2022 (PT) 118329

(51) Int. Cl. G06N 20/00

(52) U.S. Cl. CPC G06N 20/00

(57) ABSTRACT

The present document discloses a method for machine-learning fairness-aware data valuation processing for supervised learning, from a training dataset comprising a plurality of data records each containing data for a training instance for said supervised learning, wherein the data for each training instance comprises one or more target variables, one or more input variables and one or more protected-attribute variables, wherein fairness is defined as minimizing a data bias present in the training set in respect of the one or more protected variables.

### CROSS-REFERENCE

This application claims the benefit of priority under 35 U.S.C. §119(e) from Portugal Patent Application No. 118329, filed on Nov. 11, 2022, which is hereby incorporated by reference as if set forth in its entirety herein.

### FIELD

The present disclosure relates, generally, to machine learning and, more particularly, to fairness-aware data valuation processing for supervised learning.

### BACKGROUND

The field of data valuation can assess the value of training instances toward a certain predictive task, and determine how such instances influence both performance and impartiality of machine learning (ML) models. Data valuation techniques, such as for data preprocessing or active learning, that are not performance and fairness-aware, can run the risk of propagating and exacerbating bias, including as embedded within the data. Such a risk has materialized in recent years, with the rapid adoption of ML methods and systems in high-stakes decision-making settings, which has led to numerous works identifying how such methods can discriminate against certain groups, thereby giving rise to the field of fair ML.

Key factors of machine learning include the data used to train models and specific instances, which have been shown to play a crucial part in the performance of ML models. Depending on a respective metric of interest, certain training data instances may have a greater or lesser degree of value. Accordingly, the field of data valuation has arisen, with the goal of associating each training datum with a corresponding value. Various data valuation approaches can be been applied, such as noisy labels detection, and active learning, each with a varying degree of success. While data valuation has been used with respect to fairness metrics, none has with a goal of performance and fairness.

In connection with supervised learning, data valuation can be framed as follows: given a set of training data with n data instances, each characterized by a feature vector xᵢ (in which one, or more, protected attribute(s) zᵢ may be included), and a target variable yᵢ, the goal is to find the value νᵢ of each training instance, with respect to some value metric of interest V, obtained by a learning algorithm ƒ trained to predict yᵢ from xᵢ. How νᵢ is calculated can vary, such as by a game-theoretical approach and calculate the Shapley value of each data instance. In some instance i, training a model can be on all possible coalitions of training instances with and without instance i, computing V for each, and returning the difference between the average V in coalitions where i is present, and the average V in the rest of the coalitions. Although having a series of desirable properties, this method is intractable to compute and approximations have been proposed. Conversely, a reinforcement learning approach can be used, where a data valuator model is jointly trained with the predictor of the task from which V is calculated.

As for the metric of interest, V can be set as the accuracy of a predictor ƒ on unseen data (test set), with νᵢ being the importance of data instance i towards achieving the performance that predictor ƒ obtains when trained on the whole dataset. However, V can be any metric of interest, for example, aside from the usual performance metric-based data valuation, and data valuation can be performed with equalized odds difference as V.

Unfortunately, data valuation is not known to define V as a combination of performance and fairness. Instead, such components, if fairness is even mentioned, are shown separately. Except perhaps indirectly, data valuation has never been used for fairness-promoting interventions.

Notwithstanding the exceptional ML task, ML algorithms have been shown to exacerbate and propagate biases embedded within data. This is especially true when such models are trained with regard to a performance metric, and treated as unamenable black boxes.

Such a stance is particularly problematic in high-stakes decision making domains, where biased policies can result in certain social groups being systematically discriminated, and locked out of important goods and services (e.g., by race, sex). In response, use of fair ML has grown in recent years.

Just as data play a role in the performance of models, data play a role in discrimination. Indeed, data bias can shape the landscape of fairness and performance. Unfortunately, little work has been made to understand the sources of these biases.

These facts are disclosed in order to illustrate the technical problem addressed by the present disclosure.

### GENERAL DESCRIPTION

The present document discloses a computer-implemented fairness-aware data valuation (FADV), a data valuation framework, i.e., for measuring which ML training instances contribute the most to both performance and fairness of models. The framework can be used to incorporate fairness concerns into a series of ML applications (e.g., exploratory data analysis, and data pre-processing).

In one or more implementations, the present disclosure includes a method and metric to relate data bias to specific data instances. A data-centric understanding of unfairness can be provided, including to respond to gaps in the current literature from exploratory data analysis (EDA), unfairness mitigation, and active learning perspectives. Moreover, the present disclosure can be applied with any type of classification or regression task, as well with virtually any number of categorical and continuous protected attributes.

In one or more implementations, an entropy-based notion of value and utility is applied, which incorporates both performance and (procedural) fairness (data bias) concerns. To validate the method and the metric, it is showed how they could be applied in the context of an unfairness mitigation pre-processing intervention in a binary classification setting (e.g., training set sampling and reweighing). Other metrics, such as data Shapley, may not be suitable for requiring a fixed dataset.

In operation, a concise benchmark on a fraud detection dataset revealed how the method compares favourably, in terms of achieving promising fairness-accuracy trade-offs. Furthermore, a resulting value vector for the training set can provide another possible dimension for fairness-aware exploratory data analysis and incorporates fairness concerns into other actions in the ML pipeline, such as during data collection, data generation, or the like. From an EDA perspective, the instances' valuation vector can relate to the data features, since these two components are inherently connected to each other.

In one or more implementations, given a valuation vector (V), a surrogate model for the distribution P[V |X,Y, Z] is trained, and a feature importance method is applied on it. For example, SHAP can provide a landscape of local feature importances and directly link the contribution of individual features to the value of each instance on a specific predictive task.

In accordance with the teachings herein, tracing data bias to specific training instances is useful to further the understanding of algorithmic unfairness, as well as to add a layer of insight to data exploration and other tasks along the ML pipeline, including in the realm of supervised learning.

In particular, a system and method is provided for fairness-aware data valuation processing that is based on a notion of utility that incorporates the value of specific instances towards both performance and fairness (lack of data bias). The method can be used with continuous and categorical targets and protected attributes, as well as to promote subgroup fairness.

Further, the present disclosure includes an entropy-based notion of data value, which can be used in virtually any predictive task and, therefore, used to calculate an instance's value towards accurate prediction of a target Y, and data bias with respect to one or more protected attributes.

Still further, the present disclosure includes a method and system for machine-learning fairness-aware data valuation processing for supervised learning, from a training dataset comprising a plurality of data records, each containing data for a training instance (i) for the supervised learning, wherein the data for each training instance comprises one or more target variables (Y), one or more input variables (X) and one or more protected-attribute variables (Z). Fairness can be defined as minimizing a data bias present in the training set, in respect of the one or more protected variables (Z). The method further comprises the steps of: for each target variable of the one or more target variables (Y), use the training dataset for training a machine-learning model with the one or more input variables (X) as model inputs and said each target variable (Y) as model output, for each protected-attribute variable of the one or more protected-attribute variables (Z), use the training dataset for training a machine-learning model with the one or more input variables (X) as model inputs and said each protected-attribute variable (Z) as model output; obtaining a prediction of each target variable (Y) and a prediction for each protected-attribute variable (Z), for each instance of the training dataset; obtaining a performance entropy from the predictions of each said target variable (Y) and a protected-attribute entropy from the predictions of each said protected-attribute variable (Z).

In one or more implementations, the method and system further include a preparatory step of: splitting the training instances of the training dataset into a plurality of sets, each set comprising a first subset of training instances and second subset of training instances, such that each training instance is present in at least one of a second subset of the plurality of sets; the method further comprising, when training the machine-learning models and obtaining said prediction, the steps of: for each set, and for each target variable of the one or more target variables (Y), use the first subset of said each set for training a machine-learning model with the one or more input variables (X) as model inputs and said each target variable (Y) as model output; for each set, and for each protected-attribute variable of the one or more protected-attribute variables (Z), use the first subset of said each set for training a machine-learning model with the one or more input variables (X) as model inputs and said each protected-attribute variable (Z) as model output; obtaining a prediction of each target variable (Y) and a prediction for each protected-attribute variable (Z), for each instance of the second subsets.

In one or more implementations, the method and system of the present disclosure comprise, when training the machine-learning model with the one or more input variables (X) as model inputs and each target variable (Y) as model output, also using the one or more protected-attribute variables (Z) as model inputs.

In one or more implementations, the method and system of the present disclosure comprise, when training the machine-learning model with the one or more input variables (X) as model inputs and the each protected-attribute variable (Z) as model output, also using the one or more target variables (Y) as model inputs.

In one or more implementations, the splitting is random and repeated until each training instance is present in at least one of second subsets, preferably wherein each training instance is randomly allocated to one of the second subsets.

In one or more implementations, the splitting is overlapping between second subsets such that each training instance is present in one or more second subsets of the plurality of sets.

In one or more implementations, the method and system of the present disclosure includes, after splitting and before training, sampling, for each set, without replacement within each set, with replacement across sets, training instances for subsequent training.

In one or more implementations, the method further includes a step of obtaining a central value statistic from the obtained entropy over the trained models and over the second subsets of the each set; and outputting the obtained central value statistic as an instance weighing for supervised training.

In one or more implementations, the obtaining of the central value statistic comprises obtaining an average of obtained entropy over the trained models and over the second subsets of each the set.

In one or more implementations, the method further includes a step of: obtaining a utility metric, for each training instance, as a combination of the obtained performance entropy or entropies and of the obtained protected-attribute entropy or entropies.

In one or more implementations, the utility metric is a utility vector obtained, for each instance, via a linear scalarization defined as:

$${U}_{i} = α {v}_{{y}_{i}} + {\sum }_{j = 1}^{k} {β}_{j} {v}_{{z}_{ij}} ,$$

preferably Uᵢα [symbol] +(1−α) [symbol] ; more preferably wherein the one or more protected attribute variables (Z) comprise two subgroup protected attribute variables (Zₐ, Z_{b}), and wherein the utility metric is defined as combination of each instance utility for performance and each instance utility for fairness by:

$${U}_{i} = α {v}_{{y}_{i}} + β {v}_{{z}_{{a}_{i}}} + θ {v}_{{z}_{{b}_{i}}} ,$$

wherein Uᵢ is the utility metric for instance i, α is a weighing factor comprised between 0 and 1, [symbol] is a performance entropy in respect of target variable (Y) for instance i, and [symbol] is a protected-attribute entropy in respect of protected variable (Z) for instance i; wherein the one or more protected attribute variables (Z) comprise k subgroups of protected attribute variables (Z_{j=1 . . . k}).

In one or more implementations, the utility metric is a utility vector obtained, for each instance, via a multiplicative scalarization defined as:

$${U}_{i} = {v}_{{y}_{i}}^{α} \cdot {v}_{{z}_{i}}^{1 - α} ;$$

wherein Uᵢ is the utility metric for instance i, α is a weighing factor comprised between 0 and 1, [symbol] is a performance entropy in respect of target variable (Y) for instance i, and [symbol] is a protected-attribute entropy in respect of protected variable (Z) for instance i; wherein the one or more protected attribute variables (Z) comprise k subgroups of protected attribute variables (Z_{j=1 . . . k}).

In one or more implementations, the method includes carrying out supervised learning using the obtained utility metric, for each training instance, as instance weighing.

The present disclosure further includes a computer program product embodied in a non-transitory computer-readable medium comprising computer program instructions which, when executed by a computer processor, cause the computer processor to carry out the method for machine-learning fairness-aware data valuation processing.

Further, the present disclosure also includes a non-transitory storage media including program instructions for machine-learning fairness-aware data valuation processing, the program instructions including instructions executable to carry out the method.

Two examples of an algorithm to estimate the proposed metric for all instances in a training set are further disclosed.

It is further disclosed an evaluation of how the method can be used for exploratory data analysis and fairness-aware training data sampling and re-weighing on a real-world use-case. In the latter case, empirical results are presented that show that the general purpose method exhibits improved fairness-accuracy trade-offs, compared to existing methods in the literature designed specifically for the task at hand—a 25 p.p. improvement in fairness at 1 p.p. loss in performance, and in some circumstances up to 40 p.p.

### BRIEF DESCRIPTION OF THE DRAWINGS

The following figures illustrate preferred implementations consistent with the disclosure and should not be seen as limiting the scope of invention.

FIG. 1 illustrates a flowchart representation of an implementation of a method for machine-learning fairness-aware data valuation processing for supervised learning.

FIG. 2 includes a graphical representation of the entropy of classifiers Y and Z of a fairness-aware data valuation matrix split by protected group for a given base dataset.

FIG. 3 includes a graphical representation of the entropy of classifiers Y and Z of a fairness-aware data valuation matrix split by protected group for the Variant I dataset (unbiased).

FIG. 4 includes a graphical representation of the entropy of classifiers Y and Z of a fairness-aware data valuation matrix split by protected group for the Variant II dataset (prevalence disparity bias).

FIG. 5 includes a graphical representation of the entropy of classifiers Y and Z of a fairness-aware data valuation matrix split by protected group for the Variant III dataset (group-wise distinct class-conditional distribution bias).

FIGS. 6A and 6B include graphical representations of predictive equality, demographic parity, and equality of opportunity in relation to performance for no data intervention, random prevalence sampling (RPS), reweighting (RW), utility-aware sampling (UAS), utility-aware prevalence sampling (UASP), and utility-aware reweighting (UAR).

### DETAILED DESCRIPTION

The present disclosure includes a method for fairness-aware data valuation (FADV), a data valuation processing that allows measuring which training instances contribute the most to both performance and fairness of models.

Briefly, as will be appreciated, systems and methods consistent with this disclosure can be performed by software or firmware in machine readable form on a tangible (e.g., non-transitory) storage medium. For example, the software or firmware can be in the form of a computer program including computer program code adapted to cause the system to perform the monitoring and various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously. The code utilized by one or more implementations of the present invention comprise instructions that control the processor to execute methods, such as detailed herein. The instructions can comprise a program, a component, a single module, or a plurality of modules that operate in cooperation with one another. More generally, the code comprises a portion of an implementation implemented as software. The component(s) or module(s) that comprise a software implementation can include anything that can be executed by a computer such as, for example, compiled code, binary machine level instructions, assembly code, source level code, scripts, function calls, library routines, and the like. In other implementations, the code can be implemented in firmware or a hardware arrangement.

Further, use an entropy-based data valuation metric can be provided that is specifically tailored to relate to model performance and data bias concerns. This contributes to the goal of fair ML, including to incorporate fairness concerns into ML systems while keeping their performance high. FADV can be similarly used as data valuation and, as such, can be a vehicle to introduce fairness concerns into a series of upstream and downstream tasks, such as data pre-processing, active learning, data generation, and exploratory data analysis (EDA). The efficacy of FADV can be shown as a means to conduct unfairness mitigation pre-processing interventions, and to achieve better fairness in active learning.

Moreover, the present disclosure can focus on data valuation for supervised learning, where a method that defines V as a function of both performance and data bias (fairness) and shows how it can be used to promote observational fairness, being an inherently data-centric task.

To be able to reason about the types of bias present in the data, and understand how fairness-aware data valuation works under distinct biases, a data bias taxonomy is leveraged. Herein the features of a dataset are referenced as X, the class label as Y, and the protected attribute as Z. The following definitions use the inequality sign (≠) to mean a statistically significant difference, not a strict inequality.

Base Bias Condition: [symbol] [X, Y]≠ [symbol] [X, Y|Z], to satisfy this, Z must be statistically related to either X, Y, or both. The following biases imply this condition.

Prevalence Disparities: [symbol] [Y]≠ [symbol] [Y|Z], i.e., the class probability depends on the protected group.

Group-wise Class-conditional Distribution Bias: [symbol] [X|Y≠ [symbol] X|Y, Z] This condition reads ‘the distribution of the features conditioned on the target depends on the protected attribute’.

The last condition does not imply the Base bias condition, but can still be relevant for fairness: group size disparities. Let z be a particular group from a given protected attribute Z, and N the number of possible groups. Under group size disparities, one has:

$$ℙ [ Z = 𝓏 ] \neq \frac{1}{𝒩} .$$

As described herein, a key component of the method is the definition of V as a function of both performance and fairness, rather than having them be separate components. This enables for not only to accurately predict Y, but also to do it fairly.

Herein the metric of interest is referred as utility (U). This nomenclature is inspired by the economics literature, where the well-being (utility) of an individual is defined as a function of the utility derived from a weighted combination of factors (e.g., economic goods), rather than a single one. In this case, utility is a function of performance and fairness; how it is maximized depends on the definition of the function and on the weights attributed to performance and fairness. Thus, the utility of a single data instance can be written as Uᵢ(ν_{yi}, ν_{zi}), where ν_{yi} is the performance-related valuation of instance i, and ν_{zi} is the fairness-related one.

The choice of ν′s and how they interact can depend on a particular implementation, as such decisions are heavily task-dependent, such as being a Shapley value or suitable other measurement that is adequate, such as a set of desiderata for data valuation metrics as put forth by Sim et al.

In an implementation, the V metric is tied to the data bias taxonomy, such as proposed by Pombal. This metric should not, however, be seen as the only metric that can be used within the method.

Two implementations of utility functions are provided herein a linear scalarization one: Uᵢ= [symbol] +(1−α) [symbol] , where α∈ [0, 1] governs the relative weight placed on performance and fairness, and a multiplicative scalarization one:

$${U}_{i} = {v}_{{y}_{i}}^{α} \cdot {v}_{{z}_{i}}^{1 - α} ,$$

where a plays the same role as above.

Each of these utilities abide by the principles of the method, as they strike a balance between performance and fairness. However, they encode distinct preferences as far as this balance goes. For example, the multiplicative utility is zero if either valuation is zero, whereas the linear is not.

Thus, if a proprietor of the present disclosure is not interested in gains in performance, if they do not lead to some gains in fairness, they can opt for the multiplicative utility.

Accordingly, the method and system of the present disclosure allows reasoning about and obtaining fairness-aware valuations for data instances, which can then be used for downstream tasks.

In an implementation, the present disclosure is extended to applications concerned with subgroup fairness (e.g., fairness across a series of protected attributes and their combinations (for example, for protected attributes race and sex, one would be concerned with the fairness among raceᵢ/raceⱼ and sexₙ/sexₘ, instead of just one attribute)); one needs only to include several Z terms in the utility function. For example, in a case where there are two protected attributes Zₐ and Z_{b}, a linear utility function could be defined as:

$${U}_{i} = α {v}_{{y}_{i}} + {β}_{a} {v}_{{z}_{{a}_{i}}} + {β}_{b} {v}_{{z}_{{b}_{i}}} ,$$

where the scalar terms govern the utility placed on performance, and the fairness of each group.

Alternatively, if both attributes are categorical, one could include a single Z term, where Z would be the label-set defined by the union between all the possible categories in each attribute (e.g., Z would have 4 labels, if each attribute had 2 groups).

In an implementation, for k protected attributes, the utility function is defined as:

$${U}_{i} = α {v}_{{y}_{i}} + {\sum }_{j = 1}^{k} {β}_{j} {v}_{{z}_{{j}_{i}}} .$$

A challenge posed by the present disclosure is to define and calculate ν_{y} for the predictive task at hand (e.g., detecting fraud), and ν_{z} for the fairness component of the utility. These could be, for example, the data Shapley value with respect to a validation set accuracy in the predictive task (ν_{y}) and the Shapley value with respect to, for instance, a validation set equality of opportunity difference among protected groups in the same predictive task (ν_{z}).

Such a choice would be appropriate within the method, but entails two difficulties: first, it limits the user to a specific fairness metric, which often implies sacrificing others; second, data Shapley values are intractably hard to compute and, thus, must be approximated.

In one or more implementations a more metric-agnostic valuation is provided, which is inspired by uncertainty estimation and active learning (for ν_{y}), and on the data bias taxonomy, such as proposed by Pombal et al.

In one or more implementations, for some data instance i, ν_{yi} is defined as the corresponding prediction Shannon entropy, averaged over the output of one or more trained models (In binary classification, for multi-class, the metric could be cross-entropy; for regression, the metric would have to be the difference from the sample mean, for example). In binary classification, the Shannon entropy (E) for uncertainty sampling for an instance i and prediction ŷᵢ is [symbol] = [symbol] = [symbol] ᵢ [symbol] log₂ [symbol] ᵢ+(1− [symbol] ᵢ) [symbol] log₂(1− [symbol] ᵢ).

The rationale behind choosing the entropy without the target label is inspired by active learning, where there is abundant data outside the training set, but a small budget to label it, and thus it is vital to choose which instances to label. A known method in active learning is uncertainty sampling, where an ML model trained on data subsequently chooses to obtain labels for the observations on which it is most unsure (with the highest entropy). In this way, the model learns more from adding these observations to the training set, than by adding observations on which the model is sure, as the training data already contains that information. This metric is not perfect, since being confident does not necessarily ensure correctness, and high entropy observations may simply be noisy and not necessarily useful. However, it is a useful valuation heuristic, which has been shown to work well in many settings, including fraud detection. This rationale is extended to data valuation and attribute the highest values to the instances with the highest entropy (the calculation of entropy is more involved than in active learning). In other words, it is attributed less value to instances where the model is very sure, since there is reason to believe that these encode redundant information.

As for ν_{zi}, the metric can be the same, but using a predictor of Z, rather than of Y. For an instance i, a binary protected attribute zᵢ, and predicted group \hat{Z}ᵢ, one has:

[symbol]

= [symbol] = [symbol] ᵢ [symbol] log₂ [symbol] ᵢ+(1− [symbol] )ᵢ [symbol] log₂(1− [symbol] ᵢ).

A predictor of Z can be used to diagnose data bias, which is strongly related to downstream unfairness, yet not tied to a specific metric. Indeed, if such predictor were to pass an independence test among Z, X and Y—i.e., if it were no better than random at predicting Z using the rest of the data—then its predictions are expected to all have the same utility (or lack thereof) with respect to data bias. This is at least partially because they all have the same entropy (or cross-entropy, if there are more than 2 groups, or, if the attribute is continuous, the MSE would be the same if the mean of Z were predicted for every instance. If there are two groups, with different sizes, entropy would not be maximal, but would be the same across all observations in a dataset). It would either be equal to 1, if group sizes are equa —for N protected groups, the model is expected to always predict

$$\frac{1}{N}$$

—or to 0, it tnere is a majority group, as the model will predict that all observations belong to that group.

Conversely, if the model does not pass the independence test, then instances with lower entropy have features and a target variable that are more associated to Z, and thus contribute towards data bias if the model has access to them in some other predictive task (earning a lower valuation in this respect). Following this rationale, one would prefer instances with higher entropy in the task of estimating P[Z|X,Y] in order to minimize data bias. Notice that the metric is essentially the same for ν_{y} and ν_{z}, but for different reasons. In the first case, one wants to prioritize observations on which the model had more difficulty during training, since these might contain less redundant information. In the second case, where the variable in question (Z) is not the target for the task at hand, and is seen by the model even at inference time, observations were prioritized where the model had more difficulty in establishing a relationship among X, Y, and Z, leveraging the fact the model has no explicit incentive to draw such relationships. This is directly related to mitigating the base bias condition of the taxonomy, such as of Pombal et al. (P[X,Y]≠P[X,Y |Z]), and so related to promoting fairness.

This metric can also be seen as a means to promote procedural fairness: the model is instructed to pay less attention during training to the protected attribute, and whatever variables may be related with it.

The resulting combination of ν_{y} and ν_{z} is a utility measure that balances both performance and fairness by assigning lower value to redundant information about Y and excessive information about Z in the data. Using a linear scalarization utility function, one would get: Uᵢ=αE_{yi}+(1−α)E_{zi}.

Again, this entropy-based metric can easily be extended to the case of subgroup fairness by building a predictor for all the protected attributes (categorical or continuous) of concern:

$${U}_{i} = α {E}_{{y}_{i}} + {\sum }_{j = 1}^{k} {β}_{j} {E}_{{z}_{{j}_{i}}} .$$

In an implementation, the entropy is similar to that of Xu et al., but it is extended to the context of data bias and fairness, and to offline ML tasks.

Computing the required entropy-based metric for ν is not as straightforward as in active learning, since one objective is to obtain valuations for a fully-labeled training set, and for two variables (Y and Z).

In an implementation, the method relies on creating bags from the training data of seen and unseen data, and training several models on each bag, from which entropy is obtained—akin to k-fold cross-validation. This is more closely related to active learning, since it involves a component of unseen data for which the model makes predictions.

Alternatively, in one or more implementations, the process is arguably more straightforward by not involving sampling the training set, but otherwise more a measure of epistemic uncertainty rather than a combination of epistemic and aleatoric uncertainty (as is the case with the active learning case). Broadly, the latter pertains to uncertainty incorporated by the model, while the former pertains to uncertainty inherent to the data.

To obtain a measure of utility, one must run either algorithm with Y as the target (to calculate ν_{y}) and with Z as the target (to obtain ν_{z}), for the same training set, models, and bagging splits (if algorithm 1 is chosen). The final utility measure is then dependent on the chosen utility function, and its parameters.

This entropy-based valuation is best suited for a utility function to which both ν_{y} and ν_{z} contribute positively (e.g., the linear and multiplicative utilities shown previously). In terms of the desiderata for data valuation strategies, such as put forth by Sim et al., the entropy-based metric satisfies D1-D3, and D7 and D9 if the sum of the entropies of each observation is seen to be the value of the whole dataset. Algorithm 1, below, has properties that can be accessed and operated upon by executing suitable instructions in the processor.

Algorithm 1 FADV Out-of-bag Entropy Algorithm

```
Input: training set D; variable of interest var; number of bags
  n_bags; % of train in each unseen set in each bag pct_unseen;
      models to train (pre-defined by user) M
    Output: valuation vector with respect to var V
```

| | |
|---|---|
| 1: | in_bag_sets, out_of_bag_sets ← Split D into n_bags, each with |
| | pct_unseen of D into an out-of-bag set, and the rest into an |
| | in-bag set [symbol] Data is sampled without replacement within each |
| | bag, but with replacement across bags; each observation must |
| | appear in at least one set of out-of-bag data |
| 2: | v_list ← Empty list for intermediate target variable valuations |
| 3: | for in_bag, out_of_bag ∈ [in_bag_sets, |
| | out_of_bag_sets] do |
| 4: | for m ∈ M do |
| 5: | fitted_m ← Train m on in_bag to predict var |
| 6: | v ← Vector of entropies of all predictions of fitted_m |
| | on out_of_bag |
| 7: | v_list ← Append v |
| 8: | end for |
| 9: | end for |
| 10: | V ← Average entropies of each observation over all intermedi- |
| | ate valuations in v_list |

Algorithm 2 FADV In-bag Entropy Algorithm

```
Input: training set D; variable of interest var; models to train
    (pre-defined by user) M
  Output: valuation vector with respect to var V
```

| | |
|---|---|
| 1: | for m ∈ M do |
| 2: | fitted_m ← Train m on D to predict var |
| 3: | v ← Vector of entropies of all predictions of fitted_m on D |
| 4: | v_list ← Append v |
| 5: | end for |
| 6: | V ← Average entropies of each observation over all intermedi- |
| | ate valuations in v_list |

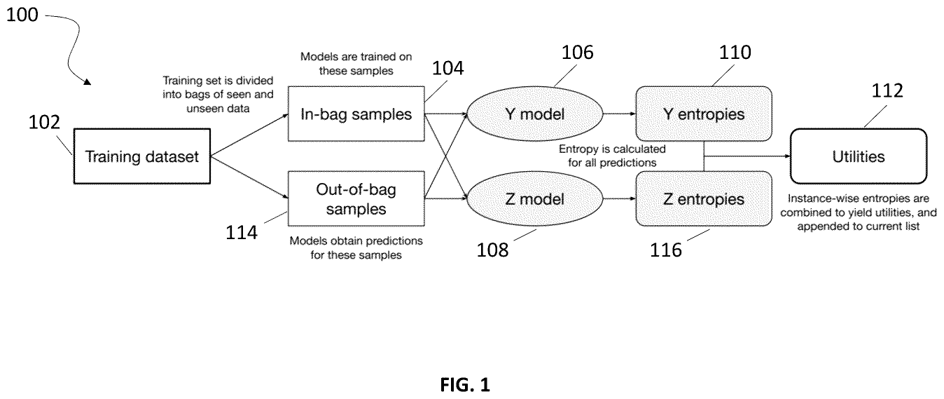

Referring now to the drawings, FIG. 1 shows a flowchart 100 representation of an implementation of the present disclosure for machine-learning fairness-aware data valuation processing for supervised learning. At step 102, a training dataset is divided into bags of seen and unseen data. In one iteration of the bagging-based algorithm for processing in-bag samples (104) comprises one model for Y (106), and one model for Z (108). In one iteration of the bagging-based algorithm for processing out-of-bag samples (114) comprises one model for Z (108), and one model for Y (106). A final utility vector is obtained by combining averaged Y entropies (110) and Z entropies.

In an example implementation, a total of 4 datasets were used in the following applications. A Base dataset called AOF, and three variants obtained from AOF (Variant I-III). AOF includes a real-world large-scale bank account-opening fraud dataset. Fraud detection is an extremely pertinent field for fair ML, for example, since holding a bank account is seen as a basic right in the European Union. In this use case of fraud, fraudsters attempt to impersonate someone to open an account, and quickly exhaust its line of credit.

Each row in the dataset corresponds to an application for opening a bank account, submitted via the online portal of a large European bank. Data were collected over an 8-month period and include over 500K rows. The first 6 months are used for training and the last 2 months are used for testing, mimicking the procedure of a real-world production environment. As a dynamic real-world environment, some distribution drift is expected across time, both from naturally-occurring changes in the behavior of legitimate customers, as well as shifts in the illicit behavior of fraudsters as they learn to better fool the production model. In terms of data biases, this Base dataset suffers from group size disparities, from prevalence disparities, and from distinct group-wise class-conditional distribution bias.

Finally, the three variants consist of the AOF dataset with synthetically injected data biases:
Variant I—synthetic binary protected attribute (Z) generated with a coinflip; this dataset is unbiased.
Variant II—synthetic binary protected attribute (Z), generated such that the data only has prevalence disparities (Z is correlated with Y only).
Variant III—synthetic binary protected attribute (Z), and two synthetic features, x₁ and x₂, which are correlated with Z and Y, such that the data has group-wise conditional class distribution bias. Importantly, only these features and Y are related to Z; the rest of the data is not.

Fraud rate (positive label prevalence) is about 1% in both sets. This means that a naïve classifier that labels all observations as not fraud achieves a test set accuracy of almost (99%). Such large class imbalance entails certain additional challenges for learning, and calls for a specific evaluation method. In particular, bank account providers are not willing to go above a certain level of FPR, because each false positive may lead to customer attrition (unhappy clients who may wish to leave the bank). At an enterprise-wide level, this may represent losses that outweigh the gains of detecting fraud. The goal is then to maximize the detection of fraudulent applicants (high global true positive rate, TPR), while maintaining low customer attrition (low global false positive rate). As such, the model's TPR was evaluated at a fixed FPR, imposed as a business requirement in the present case-study; the FPR ceiling is set to 5%. A more typical metric such as accuracy would not be informative, since it is trivial to obtain 99% accuracy by classifying all observations as not fraud (recall that fraud rate is around 1%).

As for fairness, one must ensure that automated customer screening systems do not disproportionately affect certain protected subgroups of the population, directly or indirectly. Fairness with respect to the positive labels is measured as the ratio between groupwise false negative rates (FNR). Equalizing FNR is equivalent to the well-known equality of opportunity metric, which dictates equal true positive rates (TPR), T PR=1−FNR. In the presented setting, this ensures that equal proportions of fraud are being caught for each sub-group. On the other hand, fairness with respect to the label negatives is measured as the ratio between group-wise false positive rates (FPR). Within the presented case-study, equalizing FPR (also known as predictive equality) ensures no sub-group is being disproportionately denied access to banking services. (The conclusions for demographic parity are roughly the same as for predictive equality across experiments.). Demographic parity was also measured, which assess whether the model is flagging the same percentage of individuals in each group as fraudulent.

Data valuation techniques have previously been used for tasks such as active learning and the detection of noisy/corrupted observations.

The method and data valuation metric of the present disclosure can be used for exploratory data analysis and a fairness intervention. In the latter, the knowledge of the utility of specific observations was leveraged in terms of both performance and fairness in training, to achieve better fairness-accuracy trade-offs in testing on a typical fraud detection task. To this end, sampling or reweighting procedures were applied to the training set, based on the computed valuations.

In an implementation, observations are sampled, and the most valuable ones are prioritized, or distinct weights are assigned to each observation during the training of ML models (i.e., assign larger weights to the most valuable observations). As shown and described herein, such preprocessing strategies lead to favourable fairness-accuracy trade-offs that are comparable to, or beat, known methods such as prevalence sampling and reweighing.

In operation, the AOF dataset can be used with client age as the protected attribute. Both the target and the protected attribute are binary, but it is highlighted that the data valuation method can deal with categorical or continuous variables, as well as with more than one protected attribute. The idea is to perform a sort of utility-aware sampling, or reweighting of observations in the training set, such that fairness unaware models trained on it obtain better fairness-accuracy trade-offs on unseen data (test set). To this end, the pre-processing method consists of three steps: first, computing each training instance's value with respect to Y and Z. Second, computing utility of each instance, given a utility function and respective parameters. Third, sampling or reweighing the training set before training models. If sampling is done, the instances with lower utility are discarded first. In the case of reweighting, the instances with higher utility are assigned larger weights during training.

Three strategies were considered: utility-aware sampling (UAS), utility-aware prevalence sampling (UASP), and utility-aware reweighting (UAR). UAS includes undersampling a fraction of the training set to prioritize higher utility instances (the chosen fraction is a hyperparameter of this strategy). UASP consists of undersampling the data, such that protected groups have the same prevalence (fraud rate); in the dataset, this means discarding label negatives of the group with the lowest fraud rate, starting with the instances with the least utility, until fraud rates are balanced. Finally, UAR implies assigning weights to each observation in the training set prior to training, where the weight corresponds to the instances utility—the full training set is used.

Several hyperparameter configurations of the above approaches were experimented (e.g., different valuation algorithms, utility functions, alpha parameters in the utility, training set fractions, or the like).

After each preprocessing intervention, the resulting dataset (and, optionally, instance weights) is used to train 25 LighGBM models (with hyperparameters sampled from a grid), which can then be used to make predictions on a test set (the same 25 models are used throughout). LightGBM was chosen for being a state-of-the-art algorithm for tabular data, and for easily allowing weights to be assigned to instances during training. The performance of each model is assessed with TPR at a binarization threshold such that 5%FPR is achieved, and several fairness measurements are taken: predictive equality, demographic parity, and equality of opportunity (In the form of min/max ratios; e.g., for predictive equality

$$\frac{min ( F P {R}_{A} , F P {R}_{B} )}{max ( F P {R}_{A} , F P {R}_{B} )} ,$$

such that the resulting figure lies between 0 and 1 (and since the focal point of this particular analysis is not which group is being discriminated, but rather the extent of the discrimination)). To highlight the models that achieve the best performance-fairness trade-offs, the Pareto frontier of the landscape was also analysed. The outline the 80% rule threshold as a guideline for fair models.

The fairness-aware data valuation approaches were compared with case having no intervention (the full training set), random prevalence sampling (RPS, same as UASP, but observations are randomly discarded, instead of using a utility-based order) and reweighing (RW). Referring to the predictive equality (ratio of group-wise FPR) formula analyzed by Chouldechova, for example, one can see that the RPR and RW methods are targeting solely the prevalence component of the equation, while the UASP tackles all terms, and UAS and UAR tackle the precision and TPR terms.

Having computed the valuations of each instance (using one of the proposed entropy algorithms), one can use the results to perform exploratory data analysis. Going back to the biased AOF dataset variants, such as used by Pombal et al., data valuation is used to gain further insight on data bias. To this end, the entropy of both classifiers used is plotted (one to obtain ν_{y} and the other to obtain ν_{z}) to understand how the two valuations relate under each bias condition, and gauge which instances contribute the most to bias.

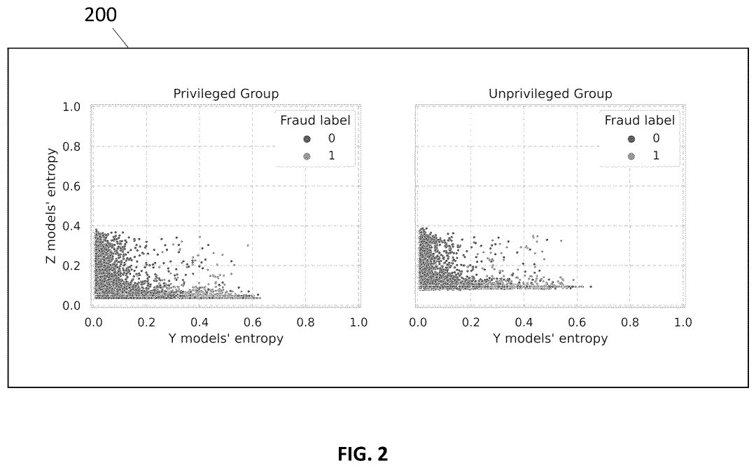

FIG. 2 shows a graphical representation 200 of the entropy of classifiers Y and Z of a fairness-aware data valuation matrix split by protected group for a base dataset (which features group size disparity, prevalence disparity, and group-wise distinct class-conditional distribution biases). Each point is a training instance. There is a negative correlation between Z and Y entropies, with the latter having a tendency to be higher for lower values of Z. While observations do not pass 0.4 in Z entropy, unprivileged group seems to have “floor” on this metric (Z entropy is never lower than 0.1), indicating that models are not as sure when classifying the protected attribute in these cases (some observations of the privileged group show entropies lower than 0.05). Thus, there is room to prioritize certain observations that contribute towards the performance valuation and not to the bias valuation.

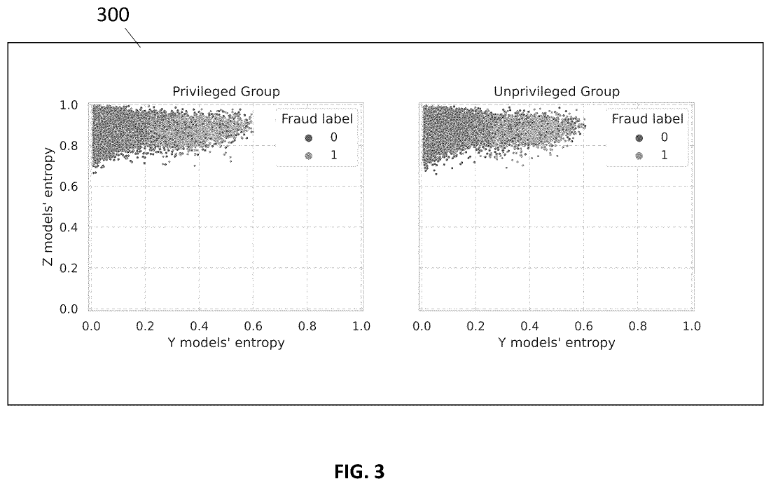

FIG. 3 shows a graphical representation 300 of the entropy of classifiers Y and Z of a fairness-aware data valuation matrix split by protected group for the Variant I dataset (unbiased). Each point is a training instance. Z entropy is high for all values of Y entropy, indicating, correctly, that the data is not biased. The distribution of entropies is very similar across protected groups, which also makes sense given the unbiased nature of this dataset. There is no benefit in utility-aware sampling or reweighing in this case.

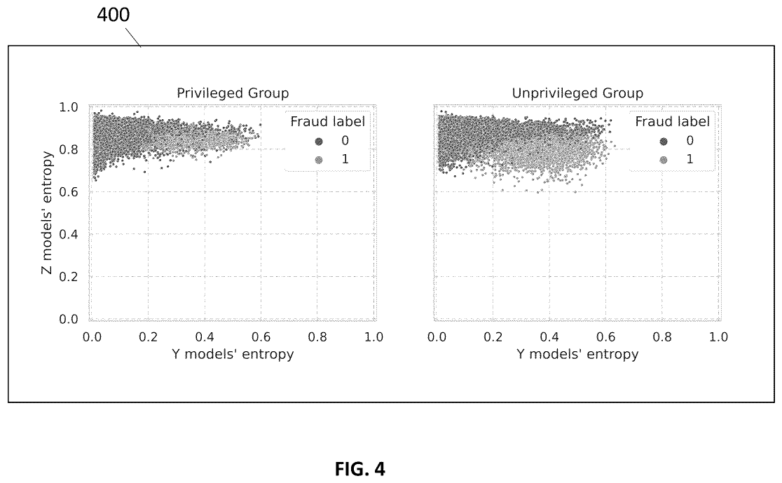

FIG. 4 shows a graphical representation 400 of the entropy of classifiers Y and Z of a fairness-aware data valuation matrix split by protected group for the Variant II dataset (prevalence disparity bias). Each point is a training instance. Tough Z entropy is generally high for both groups, the unprivileged one (higher fraud rate) has more observations of higher Y entropy and lower Z entropy. This indicates that some performance gains can be achieved by leveraging the data's biases, which is true, but detrimental to fairness.

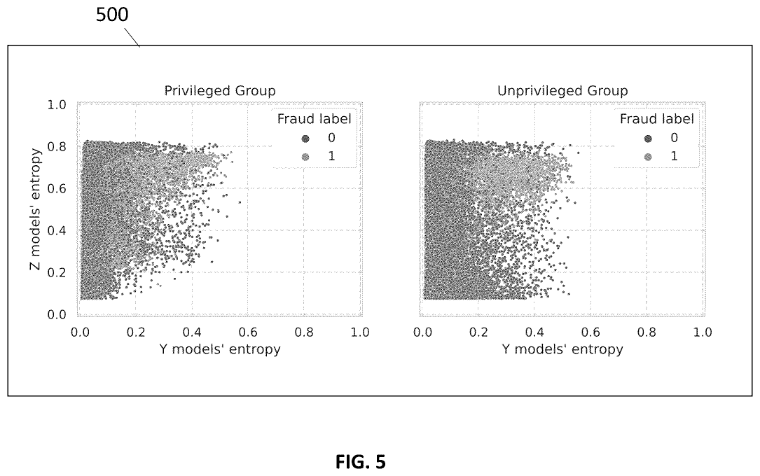

FIG. 5 shows a graphical representation 500 of the entropy of classifiers Y and Z of a fairness-aware data valuation matrix split by protected group for the Variant III dataset (group-wise distinct class-conditional distribution bias). Each point is a training instance. It is clear that Z and Y valuations correlate for the privileged group (especially for fraudulent instances). This makes sense, since the data was engineered such that fraud became easier to detect on the observations of this group. There are valuable observations for Y that are not as valuable for Z (bias), meaning there can be gains from sampling and reweighing according to utility.

With reference to FIGS. 2-5, one can see that the landscape of valuations, like the one of fairness, changes with data bias. In particular, in the cases where datasets suffer from more “aggressive” biases (the Base dataset and Variant III), there are correlations between ν_{y} and ν_{z}, which also change with the protected group under analysis. This means that there is more room to prioritize those instances that have large contributions to the predictive task (high ν_{y}), but low contributions to data bias (low ν_{z}). How this prioritization is made can depend on a respective utility function being employed.

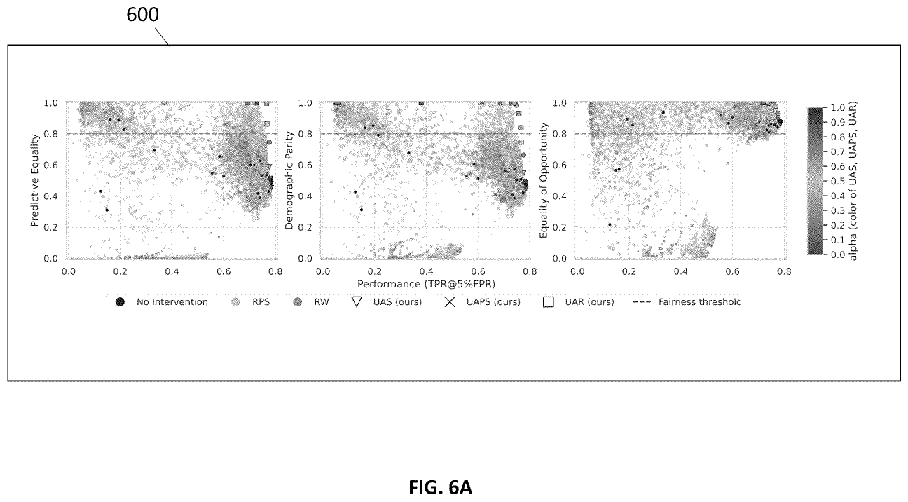

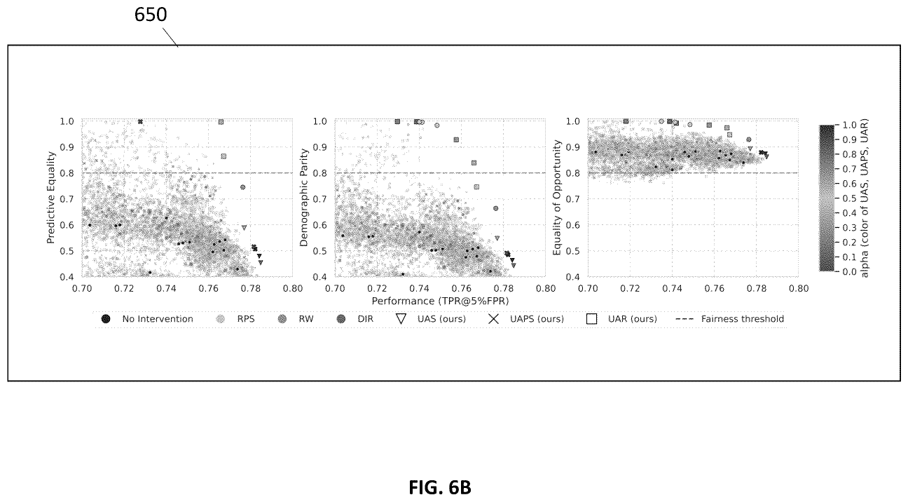

FIGS. 6A and 6B show two graphical representations 600, 650 of predictive equality, demographic parity, and equality of opportunity in relation to performance for no data intervention, random prevalence sampling (RPS), reweighting (RW), utility-aware sampling (UAS), utility-aware prevalence sampling (UASP), and utility-aware reweighting (UAR). FIG. 6B shows a zoomed version in the area of the best performance-fairness trade-offs.

Each point corresponds to one of 25 LightGBM models trained on the corresponding pre-processed training set (see legend); the same 25 models were trained for many configurations of the methods (for example, UAS has more than 10 configurations, yielding more than 250 points). The axes represent performance and fairness on the test set in the task of predicting fraud (Y). Points that lie on the Pareto frontier of the two dimensions are represented by the larger, more opaque markers. A given point lies on the Pareto frontier if there is no other point that, at that level of performance/fairness, achieves better fairness/performance.

The a bar represents the weight attributed to performance (α) and fairness (1-α) in the utility function of the methods. The sampling and reweighing techniques lie systematically on the Pareto frontier, with many non-Pareto points achieving favourable trade-offs too—beating, sometimes in performance and fairness, the models trained on the dataset without intervention.

FIGS. 6A and 6B summarize the performance-fairness trade-off landscape achieved by the models in the test set, trained on data that underwent the pre-processing techniques mentioned previously.

The relative abundance of points coloured between blue and red can be explained by the fact that for each of the proposed methods (UAS, UASP, and UAR) there are many more hyperparameters to choose from, and with which were experimented. First, as expected, there seems to be a clear relationship between alpha (the parameter that governs the weight placed on performance and data bias in the utility functions) and the fairness-accuracy landscape—the top performing models tend to be related to a higher α, while the fairest models feature lower α. Furthermore, the best trade-offs on the Pareto frontier (high performance and high fairness) seem to be achieved by mid-range values (α around 0.5), which suggests that a balanced valuation of points allows models to be much fairer at little loss in performance. Notice, for example, on the leftmost plot of FIG. 6B, the opaque squares with TPR around 0.77 and fairness above 0.85. It also seems that steep increases in fairness can be achieved with only slight drops in performance, for all fairness metrics.

Comparing the methods with those from the literature, these present the best trade-offs above the 0.8 fairness line for all three fairness metrics tested. FIG. 6B, in particular, shows that even outside the Pareto frontier, the methods seem to occupy spaces of higher fairness, for a given level of performance, than RPS and RW—especially the reweighing approach (UAR). This meets the expectations, since the methods attempt to tackle all sources of data bias, instead of just prevalence disparity which is the case with RPS and RW (though the latter achieves this in an indirect way, without discarding examples). Comparing among the presented methods, reweighing approaches seem to obtain the best trade-offs. Not only do they feature several points on the Pareto frontier of all fairness metrics, but they also seem to perform better in general. This was in part to be expected, as these methods do not require examples to be discarded, thus, in principle, leave more information in the data for models to learn from. Even disregarding fairness, one can see that the presented approaches, for high values of α, are useful to increase the performance of ML models. They can reach up to about 1 extra TPR point, when compared to the best performing models trained on the training set without intervention.

In an implementation, the ideal configuration of hyperparameters are found by receiving signal from the performance and fairness obtained on a validation set, rather than brute-force experimentation.

In another implementation, the value vector obtained as a product of the valuation procedure is used for exploratory data analysis in order to find examples that contribute to data bias, and to promote fairness in other applications like data collection and data generation.

The term “comprising” whenever used in this document is intended to indicate the presence of stated features, integers, steps, components, but not to preclude the presence or addition of one or more other features, integers, steps, components, or groups thereof.

The disclosure should not be seen in any way restricted to the implementations described and a person with ordinary skill in the art will foresee many possibilities to modifications thereof. The above-described embodiments are combinable.

The following claims further set out particular implementations of the disclosure.

What is claimed:

1. A method for machine-learning fairness-aware data valuation processing for supervised learning, from a training dataset comprising a plurality of data records each containing data for a training instance (i) for the supervised learning, wherein the data for each training instance comprises one or more target variables (Y), one or more input variables (X) and one or more protected-attribute variables (Z), wherein fairness is defined as minimizing a data bias present in the training set in respect of the one or more protected variables (Z), the method comprising:
for each target variable of the one or more target variables (Y),
training, by at least one computing device, a machine-learning model, using the training dataset, with the one or more input variables (X) as model inputs and the each target variable (Y) as model output,
for each protected-attribute variable of the one or more protected-attribute variables (Z),
training, by at least one computing device, a machine-learning model, using the training dataset, with the one or more input variables (X) as model inputs and the each protected-attribute variable (Z) as model output;
obtaining, by at least one computing device, a prediction of each target variable (Y) and a prediction for each protected-attribute variable (Z), for each instance of the training dataset;
obtaining, by at least one computing device, a performance entropy from the predictions of each the target variable (Y) and a protected-attribute entropy from the predictions of each the protected-attribute variable (Z); and
outputting, by at least one computing device, the performance entropy and the protected-attribute entropy.

2. The method according to claim 1, further comprising:
splitting, by at least one computing device during a preparatory step, the training instances of the training dataset into a plurality of sets, wherein each set comprises a first subset of training instances and second subset of training instances, such that each training instance is present in at least one of a second subset of the plurality of sets;
when training the machine-learning models and obtaining the prediction, further comprising:
for each set and for each target variable of the one or more target variables (Y):
training, by at least one computing device using the first subset of the each set, a machine-learning model with the one or more input variables (X) as model inputs and the each target variable (Y) as model output;
for each set and for each protected-attribute variable of the one or more protected-attribute variables (Z):
training, by at least one computing device using the first subset of the each set, a machine-learning model with the one or more input variables (X) as model inputs and the each protected-attribute variable (Z) as model output;
the method further comprising, when obtaining a prediction, the step of: obtaining, by at least one computing device, a prediction of each target variable (Y) and a prediction for each protected-attribute variable (Z), for each instance of the second subsets.

3. The method according to claim 1, further comprising:
using, by at least one computing device, the one or more protected-attribute variables (Z) as model inputs when training the machine-learning model with the one or more input variables (X) as model inputs and the each target variable (Y) as model output.

4. The method according to claim 1, further comprising:
using, by at least one computing device, the one or more target variables (Y) as model inputs when training the machine-learning model with the one or more input variables (X) as model inputs and the each protected-attribute variable (Z) as model output.

5. The method according to claim 2, wherein the splitting is random and repeated until each training instance is present in at least one of second subsets, and further wherein each training instance is randomly allocated to one of the second subsets.

6. The method according to claim 2, wherein the splitting is overlapping between second subsets such that each training instance is present in one or more second subsets of the plurality of sets.

7. The method according to any claim 2, further comprising:
after splitting and before training, sampling, for each set:
sampling, by at least one computing device without replacement within each set and with replacement across sets, training instances for subsequent training.

8. The method according to claim 2, further comprising:
obtaining, by at least one computing device, a central value statistic from the obtained performance entropy and the protected-attribute entropy over the trained models and over the second subsets of the each set; and
outputting, by at least one computing device, the obtained central value statistic as an instance weighing for supervised training.

9. The method according to claim 8, wherein the obtaining of the central value statistic comprises obtaining an average of obtained entropy over the trained models and over the second subsets of the each set.

10. The method according to claim 1, further comprising:
obtaining, by at least one computing device, a utility metric, for each training instance, as a combination of the obtained performance entropy or entropies and of the obtained protected-attribute entropy or entropies.

11. The method according to claim 10, wherein the utility metric is a utility vector obtained, for each instance, via a linear scalarization defined as:
$${U}_{i} = α {v}_{{y}_{i}} + {\sum }_{j = 1}^{k} {β}_{j} {v}_{{z}_{{j}_{i}}}$$
wherein Uᵢ is the utility metric for instance i, α and βⱼ are weighing factors comprised between 0 and 1, [symbol] is a performance entropy in respect of target variable (Y) for instance i,
$${v}_{{z}_{{j}_{i}}}$$
is a protected-attribute entropy in respect of protected variable zⱼ for instance i, wherein the one or more protected attribute variables (Z) comprise k protected attribute variables (Z_{j=1 . . . k}); or wherein the one or more protected attribute variables (Z) comprise two protected attribute variables (Zₐ, Z_{b}), and wherein the utility metric is defined as:
$${U}_{i} = α {v}_{{y}_{i}} + β {v}_{{z}_{{a}_{i}}} + θ {v}_{{z}_{{b}_{i}}} ,$$
and
$${v}_{{z}_{{a}_{i}}}$$
is a protected-attribute entropy in respect of a first protected variable zₐ for instance i, and
$${v}_{{z}_{{b}_{i}}}$$
is a protected-attribute entropy in respect of a second protected variable z_{b} for instance i, θ is a weighing factor comprised between 0 and 1; or Uᵢ=α [symbol] +(1−α) [symbol] , wherein ν_{z}_{ᵢ} is a protected-attribute entropy in respect of protected variable (Z) for instance i.

12. The method according to claim 10 wherein the utility metric, is a utility vector obtained, for each instance, via a multiplicative scalarization defined as:
$${U}_{i} = {v}_{{y}_{i}}^{α} \cdot {v}_{{z}_{i}}^{1 - α} ;$$
wherein Uᵢ is the utility metric for instance i, α is a weighing factor comprised between 0 and 1, [symbol] is a performance entropy in respect of target variable (Y) for instance i, and [symbol] is a protected-attribute entropy in respect of protected variable (Z) for instance i; and wherein the one or more protected attribute variables (Z) comprise k subgroups of protected attribute variables (Z_{z=1 . . . k}).

13. The method according to claim 1, further comprising carrying out supervised learning, by at least one computing device, using a utility metric obtained from a combination of the obtained performance entropy or entropies and of the obtained protected-attribute entropy or entropies, for each training instance, as instance weighing.

14. A system, comprising:
at least one computing device configured by executing instructions stored on non-transitory computer-readable medium, which when executed by the at least one computing device, configure the at least one computing device for:
for each target variable of the one or more target variables (Y),
training a machine-learning model, using the training dataset, with the one or more input variables (X) as model inputs and the each target variable (Y) as model output, for each protected-attribute variable of the one or more protected-attribute variables (Z),
training a machine-learning model, using the training dataset, with the one or more input variables (X) as model inputs and the each protected-attribute variable (Z) as model output;
obtaining a prediction of each target variable (Y) and a prediction for each protected-attribute variable (Z), for each instance of the training dataset;
obtaining a performance entropy from the predictions of each the target variable (Y) and a protected-attribute entropy from the predictions of each the protected-attribute variable (Z); and
outputting the performance entropy and the protected-attribute entropy.

15. The system according to claim 14, wherein the at least one computing device is further configured for:
splitting, during a preparatory step, the training instances of the training dataset into a plurality of sets, wherein each set comprises a first subset of training instances and second subset of training instances, such that each training instance is present in at least one of a second subset of the plurality of sets;
wherein, when training the machine-learning models and obtaining the prediction, the at least one computing device is further configured for:
for each set and for each target variable of the one or more target variables (Y):
training, using the first subset of the each set, a machine-learning model with the one or more input variables (X) as model inputs and the each target variable (Y) as model output;
for each set and for each protected-attribute variable of the one or more protected-attribute variables (Z):
training, using the first subset of the each set, a machine-learning model with the one or more input variables (X) as model inputs and the each protected-attribute variable (Z) as model output;
the method further comprising, when obtaining a prediction, the step of: obtaining a prediction of each target variable (Y) and a prediction for each protected-attribute variable (Z), for each instance of the second subsets.

16. The system according to claim 14, wherein the at least one computing device is further configured for:
using the one or more protected-attribute variables (Z) as model inputs when training the machine-learning model with the one or more input variables (X) as model inputs and the each target variable (Y) as model output.

17. The system according to claim 14, wherein the at least one computing device is further configured for:
using the one or more target variables (Y) as model inputs when training the machine-learning model with the one or more input variables (X) as model inputs and the each protected-attribute variable (Z) as model output.

18. The system according to claim 15, wherein the splitting is random and repeated until each training instance is present in at least one of second subsets, and further wherein each training instance is randomly allocated to one of the second subsets.

19. The system according to claim 15, wherein the splitting is overlapping between second subsets such that one or more training instances are present in two or more second subsets of the plurality of sets.

20. Non-transitory storage media including program instructions for machine-learning fairness-aware data valuation processing, the program instructions including instructions that, when executed by a computing device configure the computing device for:
for each target variable of the one or more target variables (Y),
training a machine-learning model, using the training dataset, with the one or more input variables (X) as model inputs and the each target variable (Y) as model output, for each protected-attribute variable of the one or more protected-attribute variables (Z),
training a machine-learning model, using the training dataset, with the one or more input variables (X) as model inputs and the each protected-attribute variable (Z) as model output;
obtaining a prediction of each target variable (Y) and a prediction for each protected-attribute variable (Z), for each instance of the training dataset;
obtaining a performance entropy from the predictions of each the target variable (Y) and a protected-attribute entropy from the predictions of each the protected-attribute variable (Z); and
outputting the performance entropy and the protected-attribute entropy.
